(19) United States
(12) Patent Application Publication
(10) Pub. No.: US 2010/0108737 A1
(43) Pub. Date: May 6, 2010

(54) Self-adjusting joining tool

(76) Inventor: Eugene J. Cox, Midlothian, VA (US)

Correspondence Address: Eugene Cox, 3980 Reed's Landing Circle, Midlothian, VA, 23113, US

(21) Appl. No.: 12/290,906

(22) Filed: Nov. 6, 2008

(51) Int. Cl. B25B 27/14; B23Q 3/00

(52) U.S. Cl. 227/113; 227/19; 227/153

(57) ABSTRACT

A simple tool that joins mitred wood corners of a picture frame with a minimum effort by eliminating several moving parts that (because of these innovations) are no longer necessary. The use of a Neodymium magnet to direct the action of the v-nails into the wood makes the usual spring load obsolete. The second unique feature of the machine is a food pedal beveled in such a fashion as to bring down the required pressure pad without prior adjustment to suit the moulding height. These improvements provide the user with a tool that will always work as intended without the need for adjustments.

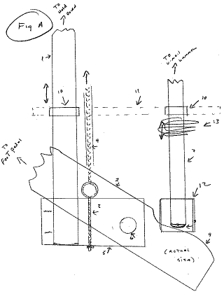

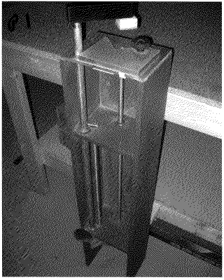

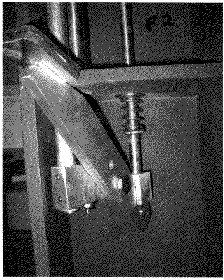

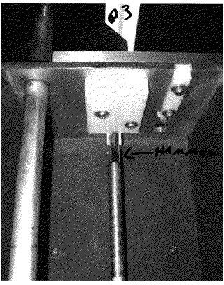

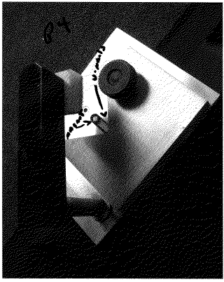

### TECHNICAL FIELD AND INDUSTRIAL APPLICABILITY OF THE INVENTION

This invention relates to the manufacture of a picture frame joining tool which, while simulating the work done by similar joining tools, reduces the effort required by employing two specific innovations not heretofore used.

### BACKGROUND OF THE INVENTION

Picture framing tools are available in a wide variety of designs and complexities but all perform the same function; they join mitered wooden corners to create a picture frame.

Joining picture frame corners was done for many years by placing the corners in a vice, gluing, then nailing the corners together.

The nail and vice process has for the most part been replaced by plastic inserts into routed frame corners or the insertion of steel V-nails into the corners. In recent years, V-nails have become the norm for most framing production.

Most V-nail machines use air pressure to drive the V-nail into the bottom of the wood while a pressure hold-down device secures the moulding from the top. Other machines accomplish the same work by a foot-operated pedal that eliminates the need for air pressure to drive the V-nail into the wood.

All of the above described machines use some form of adjustment to match the hold-down device to the height of the moulding.

All of the above described machines use some form of spring load to feed succeeding V-nails from the magazine into the point of insertion.

### FIG A

1. ¾″ rod extends 36″ to connect pressure pad at top of tool to pedal at the †he bottom.

2. Metal pedal lever pivots on block (5 and 6). Pressing down on pedal brings pad onto top of moulding.

3. Eye-hook through block connects to expansion spring. This returns the pedal and pad to rest positions.

4. Spring pulls pedal and pressure pad back to rest.

5. Block connects ¾″ rod to pedal.

6. Hole for bolt to connect block to pedal.

7. ½″ rod goes up to insert V-nail, then retracts by spring (13).

8. Pad on bottom of ½′ rod contacts with pedal lever (2).

9. Pedal lever.

10. Bushings allow both rods movement up and down.

11. Cross member of tool housing holds bushings (10).

12. Guide keeps ½″ rod on pedal lever (9).

13. Spring retracts ½″ rod.

### PICTURES

P1 TOOL PROTOTYPE

P2 SHOWS PEDAL MOVEMENT

P3 SHOWS HAMMER ON TOP OF ½″ ROD

P4 SHOWS MAGNET AND V-NAIL MAGAZINE

What is claimed is:

1. A foot operated v-nail machine that uses a NEODYMIUM (rare earth magnet) to draw V-nails into the insertion chamber without spring pressure, eliminating the need for spring load.

2. The rare earth magnet further assists in aligning v-nails and the hammer (the metal piece that drives the V-nail) so that one v-nail always goes directly into the moulding.

3. The magazine holds V-nails without the need for a cartridge, accommodating all standard size V-nails without adjustment among different sizes.

4. The unique design of the foot pedal (featuring a cam-type surface) causes the hold down pressure pad to seek the top of the moulding automatically (regardless of its height) then drive in the V-nail when that contact has been sufficiently made.

5. The operational properties of claims 1, 2, 3, and 4 cause the v-nail tool to perform its function quicker and without error as adjustments are neither necessary, nor possible.
